(19) United States
(12) Patent Application Publication
(10) Pub. No.: US 2020/0104858 A1
(43) Pub. Date: Apr. 2, 2020

(54) METHOD AND SYSTEM FOR PROACTIVELY INCREASING CUSTOMER SATISFACTION

(71) Applicant: ELEMENT AI INC., Montreal (CA)

(72) Inventors: Jeremy BARNES, Montreal (CA); Marie-Claude COTE, Montreal (CA); Alexei NORDELL-MARKOVITS, Montreal (CA)

(73) Assignee: ELEMENT AI INC., Montreal (CA)

(21) Appl. No.: 16/585,158

(22) Filed: Sep. 27, 2019

Related U.S. Application Data
(60) Provisional application No. 62/738,337, filed on Sep. 28, 2018.

(51) Int. Cl. G06Q 30/00; G06N 3/04; G06Q 30/02; G06Q 10/06

(52) U.S. Cl. CPC G06Q 30/016; G06Q 10/0637; G06Q 30/0201; G06N 3/049

(57) ABSTRACT

There is described a computer-implemented method for proactively increasing a satisfaction of a customer, comprising: receiving information about a given customer; identifying patterns of disruptive events associated with a risk factor; using the information about the given customer, associating the given customer to a given one of the identified patterns; determining a given action configured for increasing the satisfaction of the given customer, the given action being determined based on the given one of the identified patterns, the given action being one of an action to be performed and a proposed action of which a performance is to be inhibited; and outputting the action.

### TECHNICAL FIELD

The present invention relates to the field of methods and systems for increasing the satisfaction of customers, and more particularly to proactive reduction of customer churn.

### BACKGROUND

For providers such as communications service providers, reducing the churn rate of customers is of importance. Usually, such providers are aware of the dissatisfaction of a customer when the customer cancels his subscription or when he calls a call center to complain. In the latter case, the provider may take an action to increase the satisfaction of the customer or prevent the customer from cancelling his subscription. However, being aware of the dissatisfaction of a customer before he cancels his subscription or calls a call center to complain could help boosting the satisfaction of the customer and reducing the churn rate.

Therefore, there is a need for an improved method and system for proactively increasing the satisfaction of customers.

### SUMMARY

According to a first broad aspect, there is provided a computer-implemented method for proactively increasing a satisfaction of a customer, comprising: receiving information about a given customer; using the information about the given customer, associating the given customer to at least a given one of patterns of disruptive events associated with a risk factor; determining a given action configured for increasing the satisfaction of the given customer, the given action being determined based on the given one of the patterns, the given action being one of an action to be performed and a proposed action of which a performance is to be inhibited; and outputting the action.

In one embodiment, the method further comprises identifying the patterns.

In one embodiment, the step of identifying the patterns is performed based on information about customers of a given provider.

In one embodiment, the step of identifying the patterns comprises using data mining on aggregated profiles of the customers of the given provider and making observations from the aggregated profiles.

In one embodiment, the step of identifying patterns is performed based on heterogeneous information.

In one embodiment, the heterogeneous information comprises information about at least one of active customers and former customers.

In one embodiment, the heterogeneous information comprises at least one of social media data, newsfeed data and weather data.

In one embodiment, the method further comprises collecting the heterogeneous information from heterogeneous sources of information and embedding diverse collected information data into a common feature representation.

In one embodiment, the common feature representation comprises a metric space.

In one embodiment, the step of identifying the patterns is performed using a modern clustering and a long-term sequence analysis.

In one embodiment, the modern clustering comprises one of a semi-supervised spectral clustering and an active learning method.

In one embodiment, the long-term sequence analysis comprises one of a long short-term memory (LSTM) and a recurrent neural network (RNN).

In one embodiment, the step of identifying the patterns is performed using a classical clustering method.

In one embodiment, the classical clustering method comprises a singular value decomposition.

In one embodiment, the method further comprises collecting the information about a given customer on personal social media services of the given customer.

In one embodiment, the step of determining the given action is performed by comparing the information about a given customer and the patterns of patterns of disruptive events.

In one embodiment, the step of determining the given action is further based on the information about the given customer.

According to another broad aspect, there is provided a system for proactively increasing a satisfaction of a customer, comprising: a pattern identification unit for identifying patterns of disruptive events associated with a risk factor; a pattern assignment unit for receiving information about a given customer and, using the information about the given customer, associating the given customer to a given one of the patterns; and an action determining unit for determining a given action configured for increasing the satisfaction of the given customer, the given action being determined based on the given one of the identified patterns, the given action being one of an action to be performed and a proposed action of which a performance is to be inhibited, and outputting the action.

In one embodiment, the pattern identification unit is configured for identifying the patterns based on information about customers of a given provider.

In one embodiment, the pattern identification unit is configured for identifying the patterns by using data mining on aggregated profiles of the customers of the given provider and making observations from the aggregated profiles.

In one embodiment, the pattern identification unit is configured for identifying the patterns based on heterogeneous information.

In one embodiment, the heterogeneous information comprises information about at least one of active customers and former customers.

In one embodiment, the heterogeneous information comprises at least one of social media data, newsfeed data and weather data.

In one embodiment, the pattern identification unit is further configured for collecting the heterogeneous information from heterogeneous sources of information and embedding diverse collected information data into a common feature representation.

In one embodiment, the common feature representation comprises a metric space.

In one embodiment, the pattern identification unit is configured for identifying the patterns using a modern clustering and a long-term sequence analysis.

In one embodiment, the modern clustering comprises one of a semi-supervised spectral clustering and an active learning method.

In one embodiment, the long-term sequence analysis comprises one of a long short-term memory (LSTM) and a recurrent neural network (RNN).

In one embodiment, the pattern identification unit is configured for identifying the patterns using a classical clustering method.

In one embodiment, the classical clustering method comprises a singular value decomposition.

In one embodiment, the pattern assignment unit is configured for collecting the information about a given customer on personal social media services of the given customer.

In one embodiment, the action determining unit is configured for determining the given action by comparing the information about a given customer and the patterns of patterns of disruptive events.

In one embodiment, the action determining unit is configured for determining the given action further based on the information about the given customer.

### BRIEF DESCRIPTION OF THE DRAWINGS

Further features and advantages of the present invention will become apparent from the following detailed description, taken in combination with the appended drawings, in which:

FIG. 1 is a flow chart illustrated a method for proactively increasing the satisfaction of customer of a provider, in accordance with an embodiment;

FIG. 2 is a block diagram illustrating a method for creating new actions, in accordance with an embodiment;

FIG. 3 is a block diagram illustrating a system for proactively increasing the satisfaction of customer of a provider, in accordance with an embodiment; and

FIG. 4 is a block diagram of a processing module adapted to execute at least some of the steps of the method of FIG. 1, in accordance with an embodiment.

It will be noted that throughout the appended drawings, like features are identified by like reference numerals.

### DETAILED DESCRIPTION

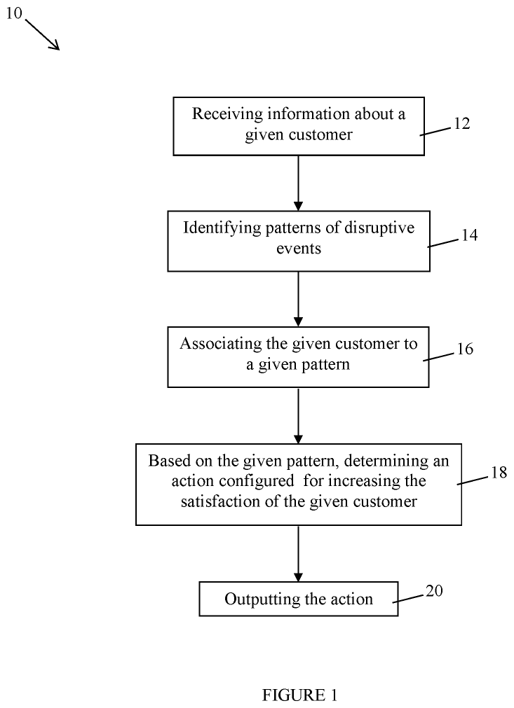

FIG. 1 illustrates one embodiment of a computer-implemented method 10 for increasing the satisfaction of the customer of a provider. The present method 10 may be used to lower the churn rate for a provider by identifying dissatisfied customers before they cancel their subscription and offering reparatory action.

The provider may be any kind of service provider or product provider offering subscriptions to its services and/or products. For example, the provider may be a telecommunications providers offering telephony and data communications services. In this case, a user may be a subscriber to a cellular phone plan, an internet plan, and/or the like. In another example, the provider may be a media company offering subscriptions to websites and/or home delivery of newspapers for example. In a further embodiment, the provider may be a music and/or video streaming provider and customer subscribes to the services of the provider to have access to music and/or videos. In still another embodiment, the provider may be an insurance company offering car insurances, home insurances, life insurances, etc. In still a further example, the provider may be a gym offering subscriptions to different sport services.

In order to determine whether a given customer is dissatisfied, the first step 12 of the method 10 consists in receiving information about the given customer. In one embodiment, the information is received from the provider and consists in all information about the customer known by the provider. In this case, the information about the customer may comprise personal information such as name, address, etc. and historical information with the provider such as financial transactions with the provider, interactions with the provider such as logs, phone calls to a call center, etc.

At step 14, patterns of disruptive events each associated with a risk factor for customers to be dissatisfied are determined using heterogeneous information as further described below.

A pattern of disruptive events is defined as a sequence or confluence of one or more events, experiences or quanta of information by a customer, which may combine to cause a customer to form a negative opinion of a product, service or service provider or a more positive opinion of an alternative product, service or service provider, or may incite a customer to reconsider the value, importance or necessity of a service to which he subscribes. For example, a pattern of disruptive events may be the reception of a phone bill that is far more expensive than the usual phone bill due to a quota of long distance minutes being exceeded. In another example, a pattern of disruptive events may be the reception of a social media message from a close friend who is satisfied with a competing service. In a further example, a pattern of disruptive events may be the reception of a weekend newspaper late two weeks in a row. In still another example, a pattern of disruptive events may be the frequent non-availability of a high speed internet service to which a customer subscribes.

In one embodiment, the information used for determining the patterns comprises information about customers known by the provider. For example, the profile of all customers of the provider may be aggregated into a database. The patterns are then determined using data mining on the aggregated profiles and making observations from the aggregated behavior of customers to disruptive events. In the case of a telecommunications provider, the disruptive events may be found from either internal maintenance data or mining of call center logs, for example.

In another embodiment, the information used for determining the patterns is heterogeneous. In this case, the information comprises customer information which may come from the aggregation of the profiles of all of the customers of the provider. The customer information may comprise historical information on active customers only or historical information on both active and former customers. Such information may be accessed by connecting to the provider systems such as the customer support system, the customer management system, and/or the like. The connection may be made to servers hosting the providers systems via application programming interfaces (APIs) for example.

While in the above description the customer information refers to the historical information about customers known by the provider, it should be understood that the customer information may also refer to the historical information known by another entity, such as a competitor for example.

The information used for determining the patterns also comprises information obtained from heterogeneous sources such as social media, newsfeed, weather data and general high-impact emotional sources that might influence a customer's behavior. In this case, the information used for determining the patterns comprise information about competitors, real-world news information, social media information, general events information such as weather information, etc.

In one embodiment, the information used for determining the patterns comprises personal information that may be collected on the customers personal social media services such as Facebook™, Linkedin™, or the like. Such information may be used to identify personal life events that may impact the satisfaction of the customers regarding the provider. In another embodiment, such information may be used to determine that a competitor may have become more attractive to a user than their existing provider. In a further embodiment, such information may be used to determine that peer pressure may result in the customer reconsidering their use of the provider.

In an embodiment in which the information used for determining the patterns is extracted from heterogeneous sources, Sensor Fusion and graph embeddings similar to the Starspace system may be used to embed the diverse collected information data into a common feature representation such as a metric space.

In another embodiment, information may be mapped into a common feature representation via the use of datasets and algorithms, either as part of the system or provided by a third party, such as geolocalization, name mapping, or via identifiers such as cookies, telephone numbers or anonymized identifiers.

In one embodiment, the patterns are extracted from the collected information using modern clustering such as semi-supervised spectral clustering or active learning methods with human in the loop involvement, and long-term sequence analysis using models such as long short-term memory (LSTM) or recurrent neural network (RNN). Such a pattern extraction method allows extracting meaning from a large matrix of data.

In a further embodiment, the patterns are extracted from the collected information using a classical clustering method such as a singular value decomposition.

Referring back to FIG. 1, once the patterns have been determined, the given customer is associated with a given pattern at step 16. This step is performed by comparing the information about the customer and the different determined patterns. The pattern for which the information about the customer matches the best the characteristics of the pattern may be elected as being the pattern to be associated with the given customer.

Alternatively, the customer may be associated with multiple given patterns using a classification or regression system such as a generalized linear model or a deep neural network, and select from multiple possible actions based upon the scores or probabilities associated to each pattern.

At step 18, an action adequate for increasing the satisfaction of the given customer is determined. In one embodiment, the action is an action to be performed. In another embodiment, the action is an action of which the performance is to be inhibited.

It should be understood that more than one action may be determined at step 18.

In one embodiment, the determination of the action is performed based on the determined pattern associated to the given customer. In another embodiment, the determination of the action is performed based on the determined pattern associated to the given customer and on the information about the given customer. For example, a different message may be sent to each customer based upon the communication preferences stored in the customer's information.

For example, an action to be performed may be an instruction to be transmitted to an employee of the provider. For example, the instruction may indicate that the provider should call the given customer. In another example, an action to be performed may be a message such as a text message or an email to be sent to the given customer. In a further example, the action may be a special offer such as a discount to be transmitted the given customer.

For example, an action of which the performance is to be inhibited may be the transmission of advertising emails to a customer. A customer may be irritated by the receipt of a too large number of emails from a provider. In this case, decreasing the number of emails sent to the customer or stopping the transmission of emails to the customer may help increasing the satisfaction of the customer and therefore reduce the customer churn.

In one embodiment, a database may comprise at least one respective action to be performed for each possible pattern. The actions stored in the database may be actions that were tested in the past and considered as successful.

In one embodiment, the system used for performing the method 10 may be trained for testing and learning new actions in response to a new pattern or an existing pattern, as described below.

At step 20, the action is outputted. In one embodiment, the action is stored in memory.

In the same or another embodiment, the action is executed. For example, when the action comprises instructions for an employee, the instructions may be transmitted to the employee. When the action is a message to be sent to the given customer, the

In one embodiment, the above-described method that uses artificial intelligence allows for new action such as offering superior service to customers who are identified as “At risk” or “Sensible to service fluctuation”. In the context of telecommunications providers, the superior service could vary from preferred access to certain websites to overall better bandwidth and similar services.

In a further embodiment, the artificial intelligence system will be consulted as to the effect of a hypothetical action as to the future probability of a customer being identified as “At Risk” or “Sensible to service fluctuation”, by performing a what-if scenario on the customer, and only allowing the action to be performed if the effect on the customer is positive with respect to the future probability.

While the actual technology used may be based on the previously mentioned data analysis and Reinforcement Learning (RL) functionalities of the system, the possibility of connecting to the network maintenance data and allowing real-time reward through targeted bandwidth and increased network performance or higher levels of service in the event of a customer being considered “At risk” is also embodied within the system.

A new action may consist in a targeted real-time discount, “break” periods based on life cycle events, for example the waiver of long distance phone charges for a customer who calls an ill relative and exceeds their allotted number of minutes, or the like. In the context of a telecommunications provider, a new action could consist in offering better network quality, lower costs, or automatically switching to or recommending a more advantageous phone plan.

A new action may also involve the automated modification of service pricing in the event that the data analysis system indicates that the customer may have charges on their bill that are unexpected to the customer and thereby make a long call to the customer service department of the provider or become “At Risk” upon receiving their bill.

In one embodiment, new actions in response to the association of customers to patterns of disruptive events may be automatically created by automatic experimentation.

In one embodiment, within targeted guidelines, automatic AB testing of actions can be performed and the resulting results are aggregated with the integrated customer history information to better decide what (and when) actions will decrease the churn rate and augment customer satisfaction.

In another embodiment, the actions may be suggested to customer service representatives of the service provider.

The method 10 may also allow the automatic discover of new customer latent variables which may then be used to obtain better target results.

In one embodiment, Reinforcement Learning (RL) may be used. While usually for an RL agent to operate, it must have access to a simulated environment that allows it to rapidly experience with various policy and aim to find the combination of policies that maximize the expected gain. This is usually unwieldy in a real life environment as the feedback loop is too long and the cost of experiment too costly.

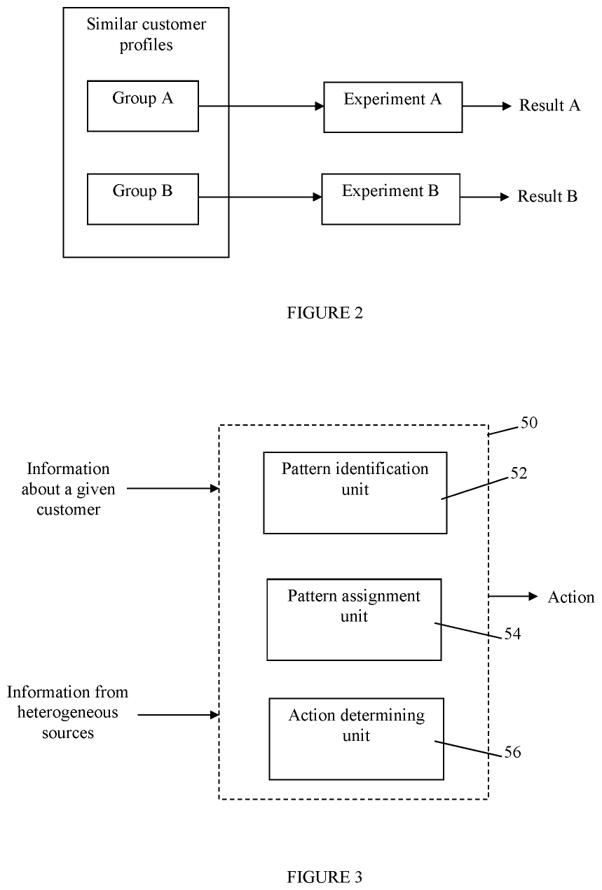

However in the context of an important customer database, it may be possible to enact sensible restrictions to the possible policies and allow the RL agent to engage in testing various policies (experiments) that will enable it to learn the best targeted applications and actions that will decrease the customer churn rate and increase customer satisfaction. The large customer database as well as the initial policies that can be gained from historical data enable a real-life RL system that can learn at a sufficient pace (by targeting small subgroups of 30-50 customers for example with various actions such as offers, discounts or techniques) while proactively discovering potential latent features in the customer/user space (by experimentation). This allows gradually learning and identifying both the actions that work best for what customers. This may also allow discovering better and novel ways of segmenting the customer base by discovering new user clusters from observing reactions to new actions. FIG. 2 illustrates such a scenario. Customers having a similar profile and to which a same or similar pattern has been assigned within the latent space of the RL system are divided into two groups, i.e. Group A and Group B. A first experiment, i.e. Experiment A, is tested on the Group A while a second and different experiment, i.e. Experiment B, is tested on the Group B. The Experiment A consists in performing a first action, i.e. Action A, when a customer of the Group A is associated with a given pattern while the Experiment B consists in performing a second and different action, i.e. Action B, when a customer of the Group B is associated with the same given pattern.

The results of the experiments are observed, i.e. the consequence of the Actions A and B on the churn rate is determined over time. If a given tested action allows increasing the satisfaction of a customer having a given profile, then the given tested action may be stored in memory for further use when a customer having a similar profile is associated with the same pattern.

FIG. 3 illustrates one embodiment of a system 50 for proactively increasing the satisfaction of customer of a provider. The system 50 comprises a pattern determining unit/module 52, a pattern assignment unit/module 54 and an action determining unit/module 56. The pattern determining unit 52 is configured for receiving information about a given customer and identifying patterns of disruptive events associated with a risk factor using a plurality of heterogeneous data sources as described above with respect to the method 10. The pattern assignment unit 54 is configured for assigning a given pattern to the given customer using the information about the given customer, as described above with respect to the method 10. The action determining unit 56 is configured for determining a given action configured for increasing the satisfaction of the given customer and outputting the action, as described above with respect to the method 10. The given action is determined based on the given pattern assigned to the customer. The given action is either an action to be performed or a proposed action of which a performance is to be inhibited.

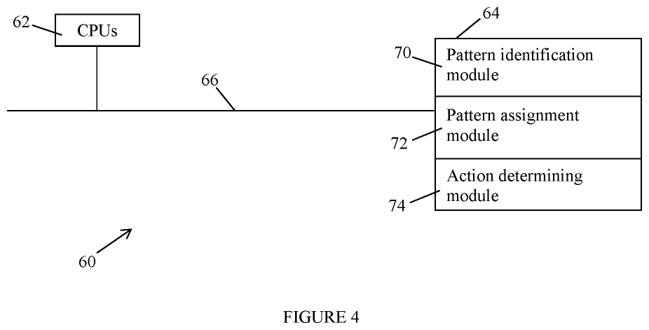

FIG. 4 is a block diagram illustrating an exemplary processing module 60 for executing the steps 12 to 20 of the method 10, in accordance with some embodiments. The processing module 60 typically includes one or more Computer Processing Units (CPUs) and/or Graphic Processing Units (GPUs) 62 for executing modules or programs and/or instructions stored in memory 64 and thereby performing processing operations, memory 64, and one or more communication buses 66 for interconnecting these components. The communication buses 56 optionally include circuitry (sometimes called a chipset) that interconnects and controls communications between system components. The memory 64 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 64 optionally includes one or more storage devices remotely located from the CPU(s) and/or GPUs 62. The memory 64, or alternately the non-volatile memory device(s) within the memory 64, comprises a non-transitory computer readable storage medium. In some embodiments, the memory 64, or the computer readable storage medium of the memory 64 stores the following programs, modules, and data structures, or a subset thereof:

a pattern identification module 70 for receiving information about a given customer and using a plurality of heterogeneous data sources, identifying patterns of disruptive events associated with a risk factor;

a pattern assignment module 72 for, using the information about the given customer, assigning a given pattern to the given customer; and

an action determining module 74 for determining a given action configured for increasing the satisfaction of the given customer, the given action being determined based on the given pattern assigned to the customer, and outputting the action.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 64 may store a subset of the modules and data structures identified above. Furthermore, the memory 64 may store additional modules and data structures not described above.

Although it shows a processing module 50, FIG. 3 is intended more as functional description of the various features which may be present in a management module than as a structural schematic of the embodiments described herein. In practice, and as recognized by those of ordinary skill in the art, items shown separately could be combined and some items could be separated.

The embodiments of the invention described above are intended to be exemplary only. The scope of the invention is therefore intended to be limited solely by the scope of the appended claims.

I/We claim:

1. A computer-implemented method for proactively increasing a satisfaction of a customer, comprising:
receiving information about a given customer;
using the information about the given customer, associating the given customer to at least a given one of patterns of disruptive events associated with a risk factor;
determining a given action configured for increasing the satisfaction of the given customer, the given action being determined based on the given one of the patterns, the given action being one of an action to be performed and a proposed action of which a performance is to be inhibited; and
outputting the action.

2. The computer-implemented method of claim 1, further comprising identifying the patterns.

3. The computer-implemented method of claim 2, wherein said identifying the patterns is performed based on information about customers of a given provider.

4. The computer-implemented method of claim 3, wherein said identifying the patterns comprises using data mining on aggregated profiles of the customers of the given provider and making observations from the aggregated profiles.

5. The computer-implemented method of claim 2, wherein said identifying patterns is performed based on heterogeneous information and the heterogeneous information comprises information about at least one of active customers and former customers, the heterogeneous information comprising at least one of social media data, newsfeed data and weather data.

6. The computer-implemented method of claim 5, further comprising collecting the heterogeneous information from heterogeneous sources of information and embedding diverse collected information data into a common feature representation.

7. The computer-implemented method of claim 2, wherein said identifying the patterns is performed using a modern clustering and a long-term sequence analysis, the modern clustering comprising one of a semi-supervised spectral clustering and an active learning method and the long-term sequence analysis comprising one of a long short-term memory (LSTM) and a recurrent neural network (RNN).

8. The computer-implemented method of claim 2, wherein said identifying the patterns is performed using a classical clustering method.

9. The computer-implemented method of claim 8, wherein the classical clustering method comprises a singular value decomposition.

10. The computer-implemented method of claim 1, wherein said determining the given action is performed by comparing the information about a given customer and the patterns of patterns of disruptive events.

11. A system for proactively increasing a satisfaction of a customer, comprising:
a pattern identification unit for identifying patterns of disruptive events associated with a risk factor;
a pattern assignment unit for receiving information about a given customer and, using the information about the given customer, associating the given customer to a given one of the patterns; and
an action determining unit for determining a given action configured for increasing the satisfaction of the given customer, the given action being determined based on the given one of the identified patterns, the given action being one of an action to be performed and a proposed action of which a performance is to be inhibited, and outputting the action.

12. The system of claim 11, wherein the pattern identification unit is configured for identifying the patterns

13. The system of claim 12, wherein the pattern identification unit is configured for identifying the patterns based on information about customers of a given provider.

14. The system of claim 13, wherein the pattern identification unit is configured for identifying the patterns by using data mining on aggregated profiles of the customers of the given provider and making observations from the aggregated profiles.

15. The system of claim 12, wherein the pattern identification unit is configured for identifying the patterns based on heterogeneous information, the heterogeneous information comprising information about at least one of active customers and former customers, and the heterogeneous information comprising at least one of social media data, newsfeed data and weather data.

16. The system of claim 15, wherein the pattern identification unit is further configured for collecting the heterogeneous information from heterogeneous sources of information and embedding diverse collected information data into a common feature representation.

17. The system of claim 12, wherein the pattern identification unit is configured for identifying the patterns using a modern clustering and a long-term sequence analysis, the modern clustering comprising one of a semi-supervised spectral clustering and an active learning method and the long-term sequence analysis comprising one of a long short-term memory (LSTM) and a recurrent neural network (RNN).

18. The system of claim 11, wherein the pattern identification unit is configured for identifying the patterns using a classical clustering method.

19. The system of claim 18, wherein the classical clustering method comprises a singular value decomposition.

20. The system of claim 11, wherein the action determining unit is configured for determining the given action by comparing the information about a given customer and the patterns of patterns of disruptive events.
